(19) United States
(12) Patent Application Publication
(10) Pub. No.: US 2005/0146741 A1
(43) Pub. Date: Jul. 7, 2005

(54) System and method for accessing the internet using a portable device by way of an internet-accessible printer

(76) Inventors: Dan L. Collier, Ridgefield, WA (US); Andrew B. Levy, West Linn, OR (US); Charles C. Newby, Cornelius, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/747,419

(22) Filed: Dec. 29, 2003

(51) Int. Cl. G06F 15/00

(52) U.S. Cl. 358/1.15; 358/402

(57) ABSTRACT

Representative embodiments provide for a system, comprising a mobile device including a web browser and a printer including a communications bridge. The communications bridge is configured to couple the mobile device in data communication with the Internet, wherein the mobile device is further configured to access the Internet by way of the communications bridge using the web browser. The present invention also provides method including providing a printer including a communications bridge, and coupling the communications bridge in data communication with the Internet. The method also provides establishing data communication between the mobile device and the Internet by way of the communications bridge, and conducting an Internet session using the mobile device by way of the communications bridge.

### BACKGROUND

Various types of portable, generally handheld electronic devices are known in the art. Examples of such mobile devices include handheld computers, person digital assistants (PDA's), cellular phones, etc. In fact, such mobile devices are now quite commonplace in both professional and personal facets of society. Furthermore, it is also known that the Internet provides access to a myriad of informational and entertainment resources, as well as serving as an increasingly popular marketplace in which to browse and shop for services and merchandise.

While it is possible to access the Internet using any number of suitable mobile devices, the scope and nature of such access is generally unsatisfactory in comparison to that typically available by way of a conventional desktop computer and hardwired Internet connection. For example, most Internet access using a mobile device requires a generally specialized service provider and/or the use of a cellular telephone network. In any case, such Internet access tends to be of relatively reduced bandwidth (i.e., reduced communications speed), of limited features, and/or requires a subscription service provided at premium cost relative to hardwired (i.e., conventional) Internet access.

Therefore, it is desirable to provide methods and apparatus for accessing the Internet using mobile devices with generally improved features, performance and relative cost.

### SUMMARY

One embodiment of the present invention provides for an Internet-capable printer. The Internet-capable printer includes a communications bridge that is configured to couple a mobile device in data communication with the Internet.

Another embodiment of the present invention provides for a system including at least one mobile device, which in turn includes a web browser. The system further includes a printer. The printer includes a communications bridge. The communications bridge of the printer is configured to couple the mobile device in data communication with the Internet. In turn, the mobile device is configured to access the Internet by way of the communications bridge using the web browser.

Yet another embodiment of the present invention provides for a printer. The printer comprises a processor configured to be coupled in data communication with the Internet. The printer further includes a computer-accessible storage media including an executable program code. The executable program code is configured to cause the processor to couple a mobile device in data communication with the Internet.

Still another embodiment of the present invention provides a method for accessing the Internet, the method including the steps of providing a printer including a communications bridge, and coupling the communications bridge in data communication with the Internet. The method also includes establishing data communication between the mobile device and the Internet by way of the communications bridge. The method further includes the step of conducting an Internet session using the mobile device by way of the communications bridge.

These and other aspects and embodiments will now be described in detail with reference to the accompanying drawings, wherein:

### DESCRIPTION OF THE DRAWINGS

FIG. 1 is a block diagram depicting a system in accordance with one embodiment of the present invention.

FIG. 2 is a flowchart depicting a first exemplary operation of the embodiment of FIG. 1.

FIG. 3 is a flowchart depicting a second exemplary operation of the embodiment of FIG. 1.

FIG. 4 is a block diagram depicting a system in accordance with another embodiment of the present invention.

FIG. 5 is a front perspective view depicting a system in accordance with still another embodiment of the present invention.

### DETAILED DESCRIPTION

In representative embodiments, the present teachings provide methods and apparatus for accessing the Internet using a mobile device by way of an Internet-capable printer (i.e., printer). The present invention provides for differing embodiments of Internet-capable printers, each including an associated communications bridge. Each communications bridge is suitably defined and configured to be coupled to the Internet by conventional wired or wireless means. Each communications bridge is further configured to couple a suitably compatible mobile device, including a web browser, in data communication with the Internet. That is, each communications bridge of the present invention is configured to suitably facilitate the bidirectional exchange of data, data packets and/or communication protocol signals between the Internet and a corresponding mobile device.

Each Internet-capable printer of the present invention also includes at least one of a docking station or a wireless transceiver. Each docking station is configured to substantially support a mobile device on or about a generally exterior region of an associated Internet-capable printer and to couple such a mobile device in data communication with the communications bridge of that Internet-capable printer. Each wireless transceiver is configured to couple a mobile device in wireless data communication with the communications bridge of an associated Internet-capable printer by way of corresponding wireless signals.

Furthermore, each Internet-capable printer (printer) of the present invention is configured to form images on sheet media (e.g., print text and/or graphics onto paper, etc.) in accordance with an electronic document file such, as for example, Internet web page content sent to a print engine of the printer by the mobile device. Therefore, each Internet-capable printer of the present invention is configured to selectively serve as both an imaging apparatus and as an Internet access host for one or more corresponding mobile devices. In this way, the present invention provides for Internet access using a mobile device that is substantially equivalent in features, performance and cost to that of a conventional Internet-coupled desktop computer.

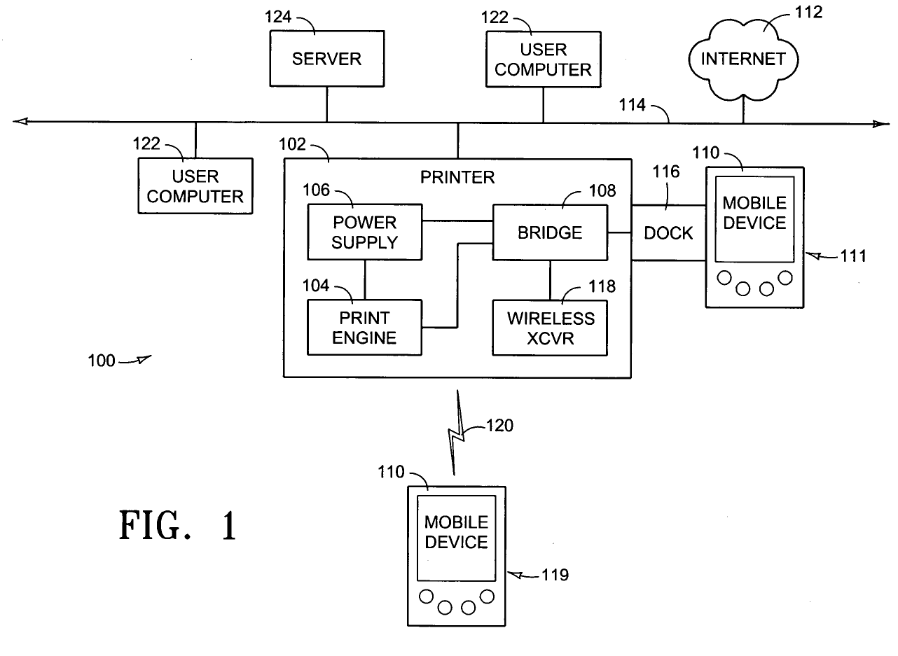

Turning now to FIG. 1, a block diagram depicts an exemplary system 100 in accordance with one embodiment of the present invention. The system 100 includes a printer 102. The printer 102 includes a print engine 104. The print engine 104 can be defined by any suitable print engine configured to selectively form images on sheet media (e.g., paper, overhead transparencies, etc., not shown) in accordance with the content of an electronic document file (not shown). Non-limiting examples of such print engines 104 include a laser print engine, an inkjet print engine, a dot-matrix print engine, etc. Other suitable print engines 104 can also be used.

The printer 102 also includes a power supply 106. The power supply 106 can be defined by any suitable power supply configured to provide electrical power to one or more elements of the printer 102 (e.g., the print engine 104, etc.). Generally, the power supply 106 derives such electrical power from a source of electrical energy (not shown) generally external to the printer 102. One of skill in the electrical arts can appreciate that such power supplies 106 are ubiquitous to devices to the printing and imaging arts and that further elaboration is not required for purposes of understanding the present invention.

The printer 102 further includes a communications bridge 108. The communications bridge 108 is generally configured to couple a mobile device 110 (described in further detail hereinafter) in data communications with the Internet 112. Thus, the communications bridge 108 is further configured to be coupled to the Internet 112 by way of a suitable wired (or wireless) data connection. As depicted in FIG. 1, the communications bridge 108 of the printer 102 is coupled to the Internet 112 by way of a local area network (LAN) 114. Other suitable data connections (not shown) can also be used to couple the communications bridge 108 with the Internet 112. Other suitable embodiments (not specifically shown) of the communications bridge 108 can be coupled to the Internet 112 by way of an IEEE 802.3 wired connection, an IEEE 802.11b wireless connection, etc.

In any case, the communications bridge 108 can be defined by any suitable electronic device or sub-system that is generally configured to handle the bidirectional exchange of data, data packets and/or communication protocol signals between a mobile device 110 and the Internet 112. Thus, the communications bridge 108 can include, for example: a program-driven microprocessor or microcontroller device; one, or more application specific integrated circuits (ASICs); a state machine; digital, analog and/or hybrid electronic circuitry; etc. One of skill in the electronic arts can appreciate that one or more suitable embodiments of the communications bridge 108 can be defined. Broadly speaking, the communications bridge 108 permits a user to access and browse (or “surf”) the Internet 112 by way of a suitably equipped mobile device 110.

The printer 102 further includes a docking station 116. The docking station 116 is generally configured to physically support a suitable mobile device 110 (depicted as docked mobile device 111 in FIG. 1) on the general exterior of the printer 102. The docking station 116 can also be configured to couple the docked mobile device 111 in electrical communication with the power supply 106 (e.g., for purposes of recharging a battery or batteries on board the docked mobile device 111). The docking station 116 is further configured to couple the docked mobile device 111 in data communication with the communications bridge 108.

As such, the docking station 116 is typically formed integral to the housing (not shown in FIG. 1) of the printer 102, and is therefore generally formed from a common housing material such as plastic, etc. Furthermore, the docking station 116 is generally configured to suitably support a plurality of electrical contacts (not shown) as required to provide for coupling the docked mobile device 111 to the power supply 106 and the communications bridge 108, respectively.

In an alternative embodiment (not shown), a printer 102 is provided that includes a docking station (not shown) substantially equivalent in function and operation to the docking station 116 of FIG. 1, but which is coupled in data communication with the communications bridge 108 and electrically coupled to the power supply 106 by way of a suitable length of electrical/communications cable that is generally exterior to the printer 102. Such an embodiment (not shown) provides a docking station (not shown) that substantially defines a discrete entity generally separate from (but electrically coupled to) the printer 102. In this way, the docking station of the alternative embodiment (not shown) can be located on a desktop or similar support for general convenience of use in conjunction with a corresponding portable device 110.

The printer 102 also includes a wireless transceiver 118. The wireless transceiver 118 is coupled in data communication with the communications bridge 108. The wireless transceiver 118 is generally configured to couple a suitably equipped mobile device 110 (depicted as wireless mobile device 119) in wireless data communication with the communications bridge 108 by way of bidirectional wireless signals 120. The wireless transceiver 118 can be defined by an infrared transceiver, a radio frequency transceiver, or a Bluetooth™ transceiver. Bluetooth is a registered mark owned by Bluetooth Sig, Inc., Washington, D.C. 20005. Other suitable wireless transceivers 118 can also be used.

One of skill in the imaging apparatus arts can appreciate that the printer 102 can also include any number of other elements and subsystems (not shown) as required and/or desired to perform any number of other normal operations. Non-limiting examples of such elements and subsystems include controllers, expendable resource reservoirs, sheet media routing and transport mechanisms, user interfaces and controls, optical scanning devices, etc. In this way, any number of suitable embodiments (not specifically shown) of the printer 102 can be defined as required and/or desired within the scope of the present invention.

It is to be further understood that other embodiments (not shown in FIG. 1) can also be provided respectively omitting one or the other of the docking station 116 or the wireless transceiver 118. In one embodiment (not shown), the printer 102 is lacking the docking station 116 and includes only the wireless transceiver 118 for purposes of providing data communication between a mobile device 110 (e.g., the wireless mobile device 119) and the Internet 112 by way of the communications bridge 108. In another embodiment (not shown), the printer 102 omits the wireless transceiver 118 and includes only the docking station 116. In such an embodiment (not shown), a mobile device 110 (e.g., the docked mobile device 111) communicates with the Internet 112 by way of the communications bridge 108 through the docking station 116.

The system 100 also includes a pair of mobile devices 110. As depicted in FIG. 1, each of the mobile devices 110 is generally defined by a handheld computer. One example of such a handheld computer is the HP iPAQ Pocket PC h4150, available from Hewlett-Packard Company, Palo Alto, Calif. 94303. Other mobile devices 110 can be defined by, for example, personal digital assistants (PDAs), cellular telephones, etc.

Each such mobile device 110 generally includes a suitably compatible web browser (not shown) configured to permit a user to selectively access the Internet 112 by way of the communications bridge 108 and one of the docking station 116 or the wireless transceiver 118. While the system 100 of FIG. 1 is depicted as including a pair of mobile devices 110, it will be appreciated that the system 100 can also be used in conjunction with any number of one or more such mobile devices 110 in accordance with the present invention.

The system 100 further includes a pair of user computers 122 and a server 124 respectively coupled in data communication with each other, the printer 102 and the Internet 112 by way of the LAN 114. The user computers 122 and the server 124 are generally depicted in system 100 of FIG. 1 to exemplify the typical environmental context in which the printer 102 and the mobile devices 110 are used. As such, specific definitions of the user computers 122 and the server 124, respectively, are not crucial to an understanding of the present invention. Exemplary operations of the system 100 are described in detail hereinafter.

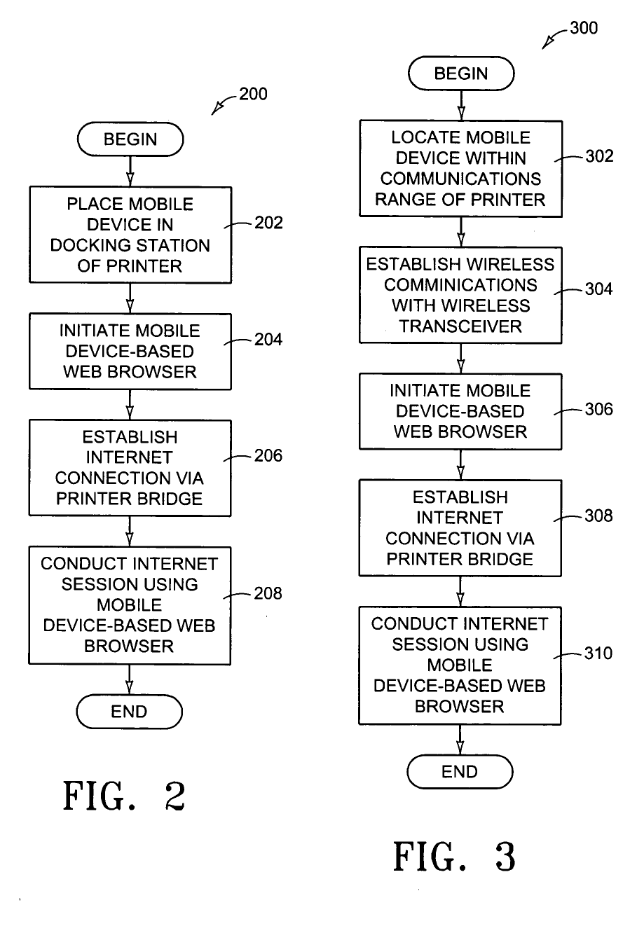

FIG. 2 is a flowchart 200 depicting a first exemplary operation of the system 100 of FIG. 1. While the flowchart 200 depicts particular steps and sequence of operation, it is to be understood that other operations respectively comprising other steps and/or sequences of operation can also be used.

In step 202 (FIG. 2), a user places the mobile device 110 (FIG. 1) into supportive engagement with the docking station 116 of the printer 102. As such, the mobile device 110 now defines the docked mobile device 111. Furthermore, the docked mobile device 111 is assumed to be coupled in data communication with the communications bridge 108 of the printer 102.

In step 204 (FIG. 2), a user initiates a web browser (not shown) of the docked mobile device 111 (FIG. 1), which provides an address signal to the communications bridge 108 requesting access to a predefined web page (i.e., homepage) on the Internet 112.

In step 206 (FIG. 2), the communications bridge 108 (FIG. 1) establishes data communication (i.e., establishes a connection) with the Internet 112 and provides a data packet to the docked mobile device 111 including present content of the predefined web page.

In step 208 (FIG. 2), a user conducts an Internet 112 (FIG. 1) session using the web browser (not shown) of the docked mobile device 111. The session can include, for example, searching for and/or browsing one or more web pages, shopping for services, visiting a news site, downloading e-mail or other electronic files into the docked mobile device 111, forwarding web page content or some other electronic document file (not shown) to the imaging engine 104 for printing on sheet media, etc.

When the user is ready to end the Internet 112 session, the web browser of the docked mobile device 111 is closed. In response to the web browser closure, the communications bridge 108 terminates data communication with the Internet 112. The first exemplary operation of the system 100 in accordance with the flowchart 200 is now complete.

FIG. 3 is a flowchart 300 depicting a second exemplary operation of the system 100 of FIG. 1. While the flowchart 300 depicts particular steps and sequence of operation, it is to be understood that other operations respectively comprising other steps and/or sequences of operation can also be used.

In step 302 (FIG. 3), a user brings a mobile device 110 (FIG. 1) into suitable communications range and/or orientation with the wireless transceiver 118 of the printer 102. For purposes of example, it is assumed that the wireless transceiver 118 is an infrared type of wireless transceiver, and that the mobile device 110 is positioned in a substantially proximate, line-of-sight orientation with the wireless transceiver 118 and/or a corresponding area of the printer 102. As such, the mobile device 110 now defines a wireless mobile device 119.

In step 304 (FIG. 3), the user of the wireless mobile device 119 (FIG. 1) establishes wireless data communications with the wireless transceiver 118, using wireless signals 120. In response, the wireless transceiver 118 establishes data communications with the communications bridge 108 in anticipation of an Internet 112 session.

In step 306 (FIG. 3), the user initiates a web browser (not shown) of the wireless mobile device 119 (FIG. 1).

In step 308 (FIG. 3), the web browser of the wireless mobile device 119 (FIG. 1) communicates a predefined web page (i.e., homepage) address to the communications bridge 108 by way of the wireless transceiver 118 and wireless signals 120. In response, the communications bridge 108 establishes data communication (i.e., establishes a connection) with the Internet 112 and provides a data packet to the docked mobile device 111 including present content of the predefined web page.

In step 310 (FIG. 3), the user conducts an Internet 112 (FIG. 1) session using the web browser (not shown) of the wireless mobile device 119. The session can include, for example, searching for and/or browsing one or more web pages, shopping for services, forwarding web page content (not shown) to the imaging engine 104 for printing on sheet media, etc.

Once the user is ready to end the Internet 112 session, the web browser of the wireless mobile device 119 is closed. In response to the web browser closure, the communications bridge 108 terminates data communication with the Internet 112, and the wireless transceiver 118 generally ceases communications with the communications bridge 108 and the wireless mobile device 119. The second exemplary operation of the system 100 in accordance with the flowchart 300 is now complete.

Because the Internet 112 sessions described above in regard to the flowchart 200 of FIG. 2 and the flowchart 300 of FIG. 3 use a generally direct connection to the Internet 112 by way of the LAN 114 and the communications bridge 108, a user of a mobile device 110 (i.e., docked mobile device 111 or wireless mobile device 119, respectively) experiences substantially the same access speed (i.e., bandwidth) as when accessing the Internet 112 by way of a conventional desktop computer (e.g., a user computer 122).

Furthermore, the user-available feature set (e.g., tools, user preferences, etc.) are limited only by the web browser (not shown) of the corresponding mobile device 110, and are substantially non-limited by any associated service provider (not shown). The result is a generally improved Internet access experience at reduced cost as compared to most mobile device Internet access options.

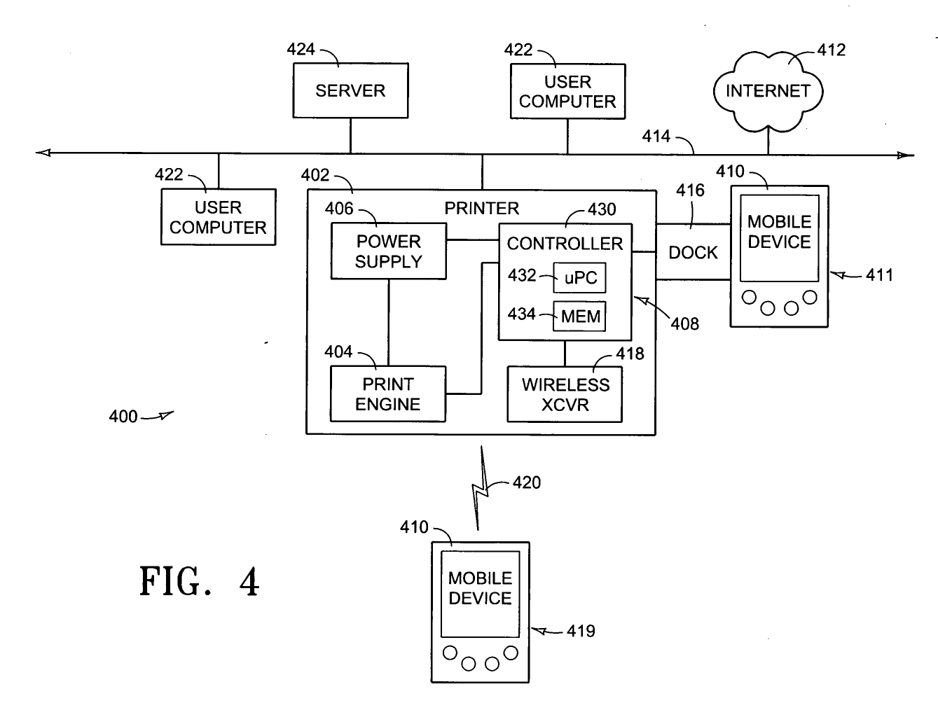

FIG. 4 is block diagram depicting a system 400 in accordance with another embodiment of the present invention. As depicted in FIG. 4, the system 400 includes a pair of mobile devices 410, the Internet 412, a local area network (LAN) 414, a pair of user computers 422 and a server 424 that are defined, configured and cooperative substantially as described above in regard to the mobile devices 110, the Internet 112, the local area network (LAN) 114, the pair of user computers 122 and the server 124, respectively, of the system 100 of FIG. 1.

The system 400 also includes a printer 402. The printer 402 includes a print engine 404, a power supply 406, a docking station 416 and wireless transceiver 418 that are defined, configured and cooperative substantially as described above in regard to the engine 104, the power supply 106, the docking station 116 and the wireless transceiver 118, respectively, of the system 100 of FIG. 1.

The printer 402 further includes a controller 430. The controller 430 includes a microprocessor (hereinafter, processor) 432 and a memory 434. The processor 432 is coupled in data communications with the docking station 416 and the wireless transceiver 418. The memory 434 includes executable program code (not shown) configured to cause the processor 432 to control a plurality of normal operations of the printer 402. For example, the processor 432 is coupled in signal communication with the print engine 404 such that the processor 432 can selectively cause the print engine 404 to image one or more sheets of media (not shown) in accordance with the executable program code (not shown) of the memory 434. Other normal operations of the printer 402 can also be controlled by the processor 432 of the controller 430. The processor 432 is also coupled to the Internet 412 by way of suitable connection to the LAN 414. Such a connection can be defined by, for example, an IEEE 802.3 wired connection, an IEEE 802.11b wireless connection, another form of wired connection, etc.

The memory 434 includes other executable program code (not shown) that is configured to cause the processor 432 to function as a communications bridge substantially as described above in regard to the communications bridge 108 of the printer 102 of FIG. 1. Thus, the processor 432, during execution of the corresponding executable program code (not shown) of the memory 434, can operate to couple a mobile device 410 in data communication with the Internet 412. In this way, the controller 430 also generally defines a communications bridge 408.

Exemplary operations of the system 400 are substantially as described above in regard to the flowchart 200 of FIG. 2 and the flowchart 300 of FIG. 3. For example, a user can bring a mobile device 410 into selective engagement with the docking station 416, thus defining a docked mobile device 411. Thereafter, the user can initiate and conduct an Internet 412 session using a web browser (not shown) of the docked mobile device 411 by way of the communications bridge 408 substantially as described above in regard to the flowchart 200 of FIG. 2.

In another example, a user can bring a mobile device 410 into wireless communications range with the wireless transceiver 418, thus defining a wireless mobile device 419. The user can then initiate and conduct an Internet 412 session using a web browser (not shown) of the wireless mobile device 419 by way of the communications bridge 408 substantially as described above in regard to the flowchart 300 of FIG. 3.

One of skill in the electronic arts can appreciate that other embodiments (not shown) of controller 430 can be defined using respectively suitable combinations of microprocessor (or microcontroller) and executable program code such that normal operations of the printer 402 and bidirectional communications between a mobile device 410 are controlled and facilitated thereby.

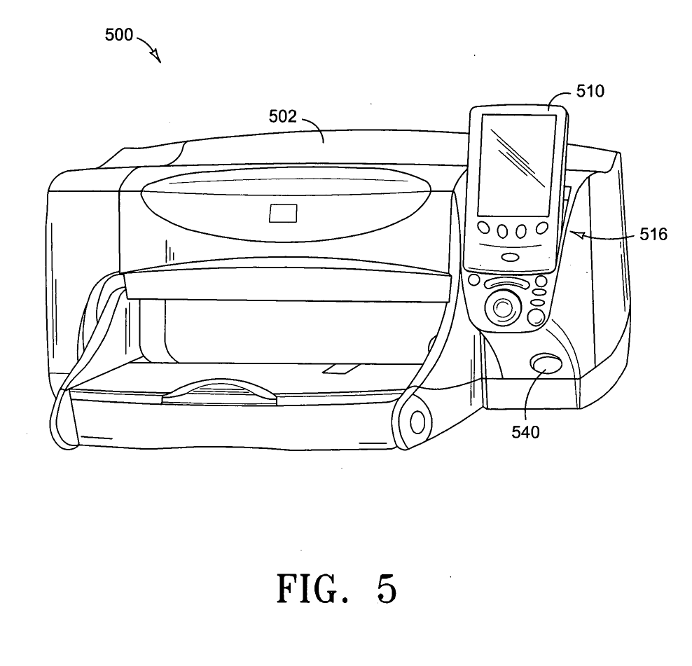

FIG. 5 is a front perspective view depicting a system 500 in accordance with still another embodiment of the present invention. The system 500 includes a printer 502. The printer 502 can be defined by any suitable printer generally configured to selectively form images on sheet media in accordance with an electronic document file (not shown), typically communicated to the printer 502 by a user computer or similar electronic entity (not shown in FIG. 5, see the user computers 122 of FIG. 1). For purposes of example, it is assumed that the printer 502 is generally defined by an inkjet printer.

The system 500 also includes a mobile device 510. The mobile device 510 can be defined by any suitable, generally handheld electronic computational device such as, for example, a PDA, a handheld computer, etc. For purposes of example, it is assumed that the mobile device 510 is defined by a handheld computer such as the HP iPAQ Pocket PC h4150 discussed above. It is further assumed that the mobile device 510 includes a suitably compatible web browser (not shown).

The printer 502 includes a docking station 516. The docking station 516 is substantially defined as an integral portion of the printer 502. The docking station 516 is generally configured to support the mobile device 510 in coupled arrangement with a plurality of electrical contacts (not shown) such that the mobile device 510 is coupled in electrical communication with a power supply and in data communication with a communications bridge (not shown in FIG. 5, see the power supply 106 and the communications bridge 108, respectively, of FIG. 1). Thus, the printer 502 is generally configured to provide Internet access to a user of the mobile device 510 by way of a suitable connection (wired or wireless) between the printer 502 and the Internet.

As depicted in FIG. 5, the printer 502 also includes an infrared port 540. The infrared port 540 is assumed to permit the passage of infrared communication signals between a suitably equipped mobile device (e.g., the mobile device 510) and a corresponding wireless transceiver (not shown in FIG. 5, see the wireless transceiver 118 of FIG. 1) coupled in data communication with a communications bridge of the printer 502.

It is to be understood that the printer 502 can also include a suitable wireless transceiver (not shown in FIG. 5, see the wireless transceiver 118 of FIG. 1) configured to couple the mobile device 510 in wireless bidirectional data communication with the Internet via a communications bridge (not shown in FIG. 5) of the printer 502. Such a wireless transceiver (not shown in FIG. 5) can be defined by a Bluetooth™ transceiver, an IEEE 802.11 WiFi transceiver, or any other suitable wireless (i.e., radio frequency) transceiver.

FIG. 5 is generally intended to depict one possible embodiment of printer 502 and compatible mobile device 510, such that bidirectional communications between the mobile device 510 and the Internet can be conducted substantially as described above in regard to the flowcharts 200 and 300 of FIGS. 2 and 3, respectively.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the doctrine of equivalents.

1. An Internet-capable printer, comprising:
a communications bridge configured to couple a mobile device in data communication with the Internet.

2. The Internet-capable printer of claim 1, and further comprising a wireless transceiver configured to wirelessly couple the mobile device in data communication with the communications bridge.

3. The Internet-capable printer of claim 2, and wherein the wireless transceiver is defined by at least one of an infrared transceiver, a radio frequency transceiver, or a Bluetooth™ transceiver.

4. The Internet-capable printer of claim 1, and further comprising a docking station configured to electrically couple the mobile device in data communication with the communications bridge.

5. The Internet-capable printer of claim 4, and wherein the docking station is further configured to electrically couple the mobile device to a power supply of the printer.

6. The Internet-capable printer of claim 1, and wherein the Internet-capable printer is configured to:
receive an electronic document file from the mobile device by way of the communications bridge; and
image one or more sheets of media in accordance with the electronic document file.

7. The Internet-capable printer of claim 1, and wherein the communications bridge is further configured to be coupled in data communication with the Internet by way of at least one of a wired connection, a wireless connection, an IEEE 802.3 wired connection, or an IEEE 802.11b wireless connection.

8. A method for accessing the Internet, comprising:
providing a printer including a communications bridge;
coupling the communications bridge in data communication with the Internet;
establishing data communication between the mobile device and the Internet by way of the communications bridge; and
conducting an Internet session using the mobile device by way of the communications bridge.

9. The method of claim 8, and further comprising:
providing a docking station included with the printer; and
electrically coupling the mobile device in data communication with the communications bridge by way of the docking station.

10. The method of claim 9, and further comprising:
providing a power supply included with the printer; and
electrically coupling the mobile device to the power supply by way of the docking station.

11. The method of claim 8, and further comprising:
providing a wireless transceiver included with the printer; and
wirelessly coupling the mobile device in data communication with the communications bridge by way of the wireless transceiver.

12. The method of claim 8, and wherein:
the mobile device includes a web browser; and
conducting the Internet session is performed using the web browser of the mobile device.

13. The method of claim 8, and further comprising:
sending an electronic document file from the mobile device to the printer; and
imaging one or more sheets of media in accordance with the electronic document file using the printer.

14. A system, comprising:
a mobile device including a web browser; and
a printer including a communications bridge, the communications bridge configured to couple the mobile device in data communication with the Internet, wherein the mobile device is further configured to access the Internet by way of the communications bridge using the web browser.

15. The system of claim 14, and wherein the printer further includes a docking station configured to electrically couple the mobile device in data communication with the communications bridge.

16. The system of claim 15, and wherein:
the printer further includes a power supply; and
the docking station is further configured to electrically couple the mobile device to the power supply.

17. The system of claim 14, and wherein the printer further includes a wireless transceiver configured to wirelessly couple the mobile device in data communication with the communications bridge.

18. The system of claim 17, and wherein the wireless transceiver is defined by at least one of an infrared transceiver, a radio frequency transceiver, or a Bluetooth™ transceiver.

19. The system of claim 14, and wherein the communications bridge is further configured to be coupled in data communication with the Internet by way of at least one of a wired connection, a wireless connection, an IEEE 802.3 wired connection, or an IEEE 802.11b wireless connection.

20. A printer, comprising:
a processor configured to be coupled in data communication with the Internet; and
a computer-accessible storage media including an executable program code, the executable program code configured to cause the processor to:
couple a mobile device in data communication with the Internet.

21. The printer of claim 20, and wherein:
the printer further comprises a print engine coupled in signal communication with the processor; and
the executable program code is further configured to cause the processor to:
receive an electronic document file from the mobile device; and
cause the print engine to image one or more sheets of media in accordance with the electronic document file.

22. A printer means, comprising:
bridge means for coupling a mobile device in data communication with the Internet; and
at least one of a docking means or a wireless transceiver means for coupling the mobile device in data communication with the bridge means.
